(19) United States
(12) Patent Application Publication
(10) Pub. No.: US 2026/0100740 A1
(43) Pub. Date: Apr. 9, 2026

(54) CHANNEL STATE INFORMATION (CSI) CONFIGURATION RECOMMENDATION

(71) Applicant: QUALCOMM Incorporated, San Diego, CA (US)

(72) Inventors: Hui Guo, Beijing (CN); Kapil Gulati, Belle Mead, NJ (US); Lan Yu, Beijing (CN); Kyle Chi Guan, New York, NY (US); Libin Liu, Monterey Park, CA (US); Gene Wesley Marsh, San Diego, CA (US)

(21) Appl. No.: 19/158,704

(22) PCT Filed: Apr. 18, 2023
(86) PCT No.: PCT/CN2023/088896

§ 371 Date: Aug. 21, 2025

(51) Int. Cl. H04B 7/06; H04L 5/00

(52) U.S. Cl. CPC H04B 7/0626; H04L 5/0057

(57) ABSTRACT

This disclosure provides systems, methods, and devices for wireless communication that support a channel state information (CSI) configuration. In a first aspect, a method of wireless communication includes generating, based on sensing information, an indicator that indicates a CSI recommendation. The CSI recommendation includes a recommended channel state information reference signal (CSI-RS) configuration, a recommended CSI reporting scheme, or a combination thereof. The method also includes transmitting the indicator. Other aspects and features are also claimed and described.

### TECHNICAL FIELD

Aspects of the present disclosure relate generally to wireless communication systems, and more particularly, to a channel state information (CSI) configuration recommendation. Some features may enable and provide improved communications, including reduced control overhead, efficient resource utilization, improved network access, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

A base station 105 may control (e.g., provide) a channel state information (CSI) configuration to a user equipment (UE). The CSI configuration may include or indicate a channel state information-reference signal (CSI-RS) configuration, a CSI reporting scheme, or a combination thereof. The CSI configuration provided to the UE may enable the UE to measure channel conditions based on a reference signal and to generate and transmit a CSI report to the base station. However, the downlink channel state may be related to movement of the UE and a change in channel conditions is likely to occur based on the movement of the UE. In such situations, the base station has to react to wait to receive the CSI report in order to be able to react to the changing channel conditions, which may reduce a quality of service experienced by the UE. Additionally, or alternatively, in situations where the UE is moving in a dense environment (e.g., an area with a lot of objects or buildings), the base station may have to frequently adjust or change the CSI configuration of the UE, thereby increasing an amount of overhead signaling.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a user equipment (UE). The method includes generating, based on sensing information, an indicator that indicates a channel state information (CSI) recommendation The CSI recommendation includes a recommended channel state information reference signal (CSI-RS) configuration, a recommended CSI reporting scheme, or a combination thereof. The method also includes transmitting the indicator.

In an additional aspect of the disclosure, a UE includes a memory and at least one processor coupled to the memory. The memory stores processor-readable code. The at least one processor is configured to execute the processor-readable code to cause the at least one processor to generate, based on sensing information, an indicator that indicates a CSI recommendation The CSI recommendation includes a recommended CSI-RS configuration, a recommended CSI reporting scheme, or a combination thereof. The at least one processor is further configured to execute the processor-readable code to cause the at least one processor to transmit the indicator.

In an additional aspect of the disclosure, an apparatus includes means for generating, based on sensing information, an indicator that indicates a CSI recommendation The CSI recommendation includes a recommended CSI-RS configuration, a recommended CSI reporting scheme, or a combination thereof. The apparatus further includes means for transmitting the indicator.

In an additional aspect of the disclosure, a non-transitory computer-readable medium stores instructions that, when executed by a processor, cause the processor to perform operations. The operations include generating, based on sensing information, an indicator that indicates a CSI recommendation The CSI recommendation includes a recommended CSI-RS configuration, a recommended CSI reporting scheme, or a combination thereof. The operations further include transmitting the indicator.

In an additional aspect of the disclosure, an apparatus includes at least one processor coupled to a memory storing processor-readable code. The at least one processor is configured to execute the processor-readable code to cause the at least one processor to generate, based on sensing information, an indicator that indicates a CSI recommendation The CSI recommendation includes a recommended CSI-RS configuration, a recommended CSI reporting scheme, or a combination thereof. The apparatus further includes a communication interface configured to transmit the indicator.

In one aspect of the disclosure, a method for wireless communication is performed by a base station. The method includes receiving, from a UE, an indicator based on sensing information. The indicator indicates a CSI recommendation. The CSI recommendation includes a recommended CSI-RS configuration, a recommended CSI reporting scheme, or a combination thereof. The method further includes transmitting a CSI configuration. The CSI configuration is based on the indicator.

In an additional aspect of the disclosure, a base station includes a memory and at least one processor coupled to the memory. The memory stores processor-readable code. The at least one processor is configured to execute the processor-readable code to cause the at least one processor to receive, from a UE, an indicator based on sensing information. The indicator indicates a CSI recommendation. The CSI recommendation includes a recommended CSI-RS configuration, a recommended CSI reporting scheme, or a combination thereof. The at least one processor is further configured to execute the processor-readable code to cause the at least one processor to transmit a CSI configuration. The CSI configuration is based on the indicator.

In an additional aspect of the disclosure, an apparatus includes means for receiving, from a UE, an indicator based on sensing information. The indicator indicates a CSI recommendation. The CSI recommendation includes a recommended CSI-RS configuration, a recommended CSI reporting scheme, or a combination thereof. The apparatus further includes means for transmitting a CSI configuration. The CSI configuration is based on the indicator.

In an additional aspect of the disclosure, a non-transitory computer-readable medium stores instructions that, when executed by a processor, cause the processor to perform operations. The operations include receiving, from a UE, an indicator based on sensing information. The indicator indicates a CSI recommendation. The CSI recommendation includes a recommended CSI-RS configuration, a recommended CSI reporting scheme, or a combination thereof. The operations further include transmitting a CSI configuration. The CSI configuration is based on the indicator.

In an additional aspect of the disclosure, an apparatus includes a communication interface configured to receive, from a UE, an indicator based on sensing information. The indicator indicates a CSI recommendation. The CSI recommendation includes a recommended CSI-RS configuration, a recommended CSI reporting scheme, or a combination thereof. The apparatus further includes at least one processor coupled to a memory storing processor-readable code. The at least one processor is configured to execute the processor-readable code to cause the at least one processor to generate a CSI configuration. The CSI configuration is based on the indicator.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports a channel state information (CSI) configuration recommendation according to one or more aspects.

FIG. 5 is a diagram illustrating an example of content of a UE report according to one or more aspects.

FIG. 6 is a flow diagram illustrating an example process that supports a CSI configuration recommendation according to one or more aspects.

FIG. 7 is a block diagram of an example UE that supports a CSI configuration recommendation according to one or more aspects.

FIG. 8 is a perspective view of a motor vehicle with a driver monitoring system according to one or more aspects.

FIG. 9 is a flow diagram illustrating an example process that supports a CSI configuration recommendation according to one or more aspects.

FIG. 10 is a block diagram of an example base station that supports a CSI configuration recommendation according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support a channel state information (CSI) configuration recommendation. For example, the present disclosure describes a user equipment (UE), such as an automobile, that is configured to generate a CSI recommendation. To illustrate, the UE may generate the CSI recommendation that includes a recommended channel state information reference signal (CSI-RS) configuration, a recommended CSI reporting scheme, or a combination thereof. In some implementations, the UE may determine the CSI recommendation based on sensing information that includes perceived situational information. The perceived situational information may be based on sensor information, channel measurement information, or a combination thereof. The UE may transmit an indicator that indicates the CSI recommendation and the indicator may be included in a CSI report or may be transmitted separate from the CSI report. Additionally, or alternatively, the indicator may be transmitted periodically as part of the CSI report or based on detection of a trigger condition. In response to receiving the indicator, a base station may adjust a CSI configuration of the UE.

Particular implementations of the subject matter described in this disclosure may be implemented to realize one or more of the following potential advantages or benefits. In some aspects, the present disclosure provides techniques for supporting a CSI configuration recommendation. The techniques described herein enable a UE, such as a UE including a sensing ability, to recommend a CSI configuration, such as a CSI-RS configuration, a CSI-RS density, a CSI-RS period, a CSI report trigger condition, a CSI report scheme, a combination thereof. By providing the recommended CSI configuration, the UE can enable the base station to adjust the CSI-RS based changing channel conditions, which may be based on movement of the UE. The base station can quickly react to the changing channel conditions and avoid reduced channel quality or quality of service experienced by the UE.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mm Wave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

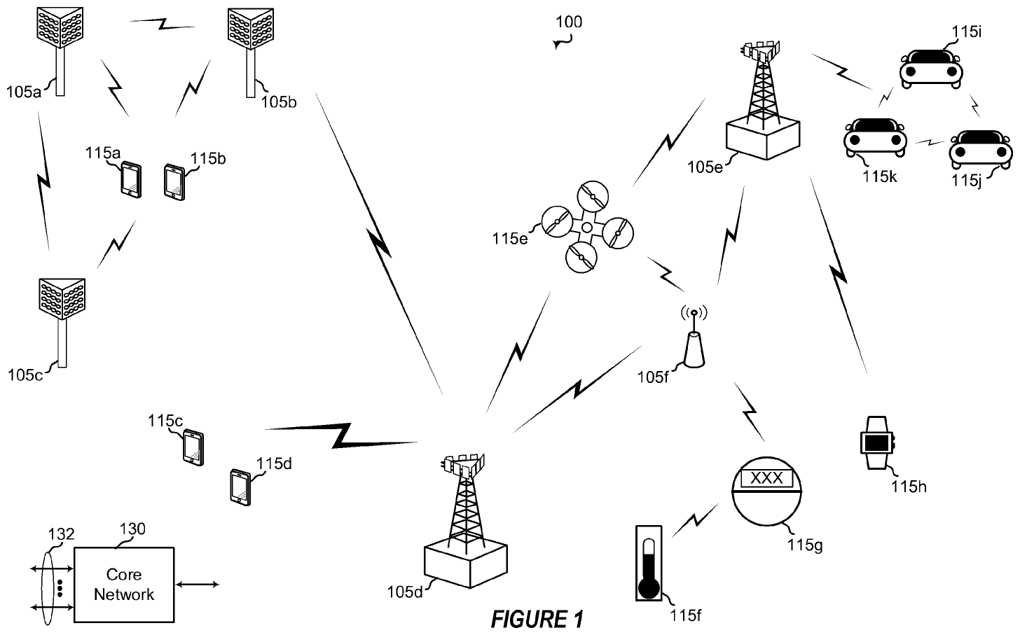

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF), which is an entity in the 5G Core Network (5GC) supporting various functionality, such as managing support for different location services for one or more UEs. For example the LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via an Access and Mobility Management Function (AMF).

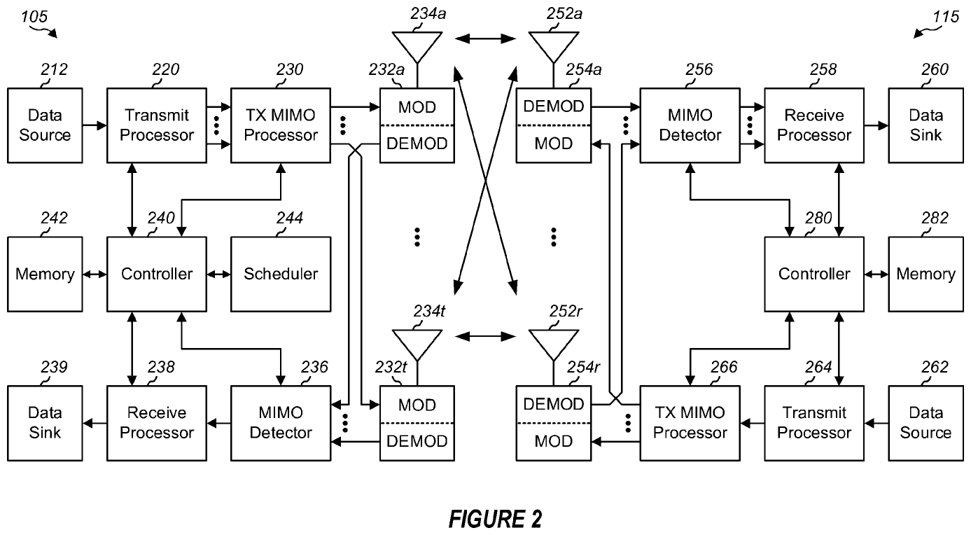

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

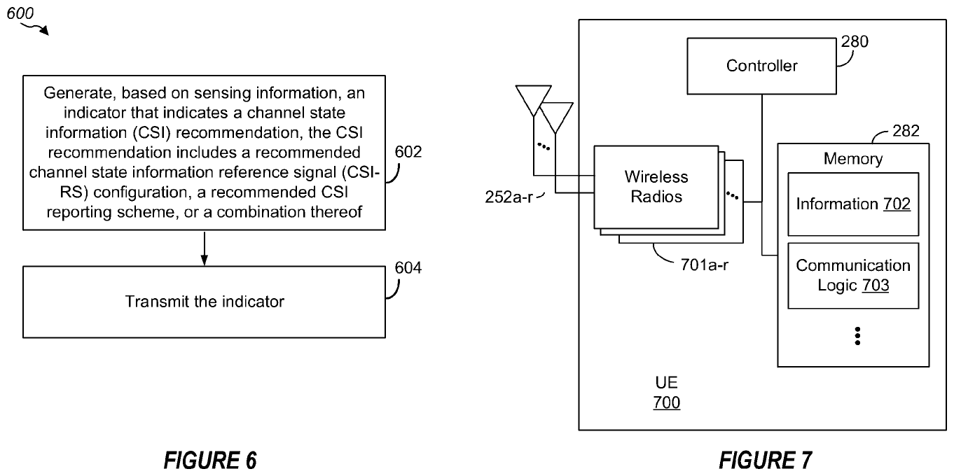

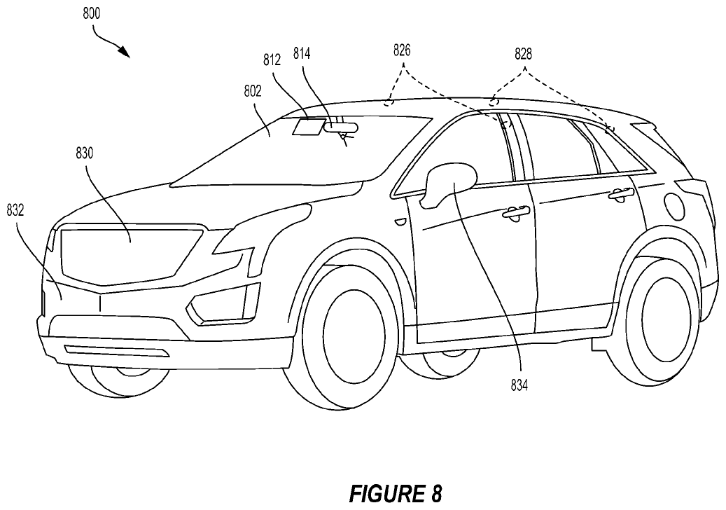

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 6 and 8, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

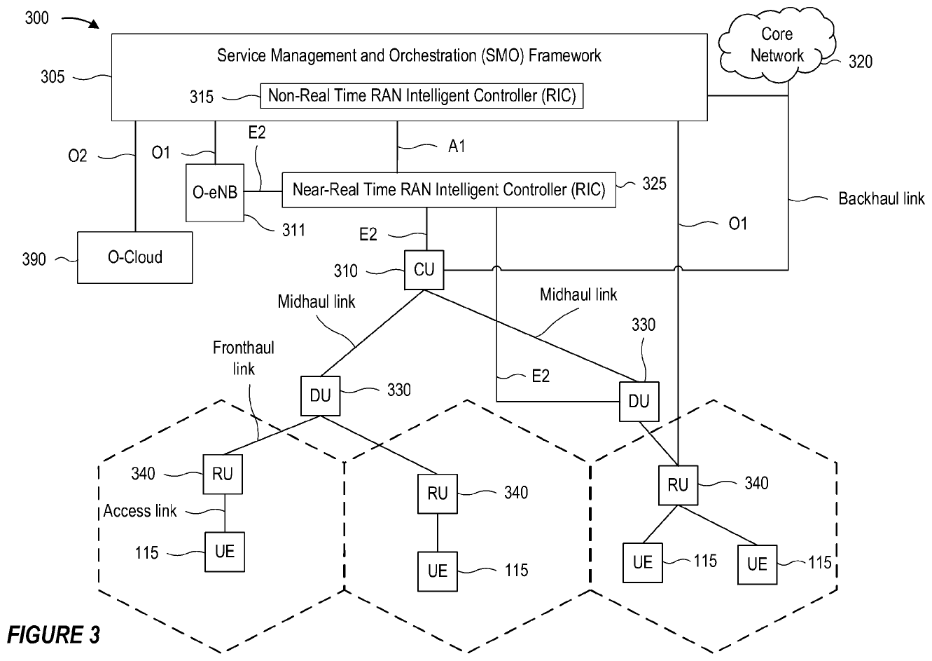

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

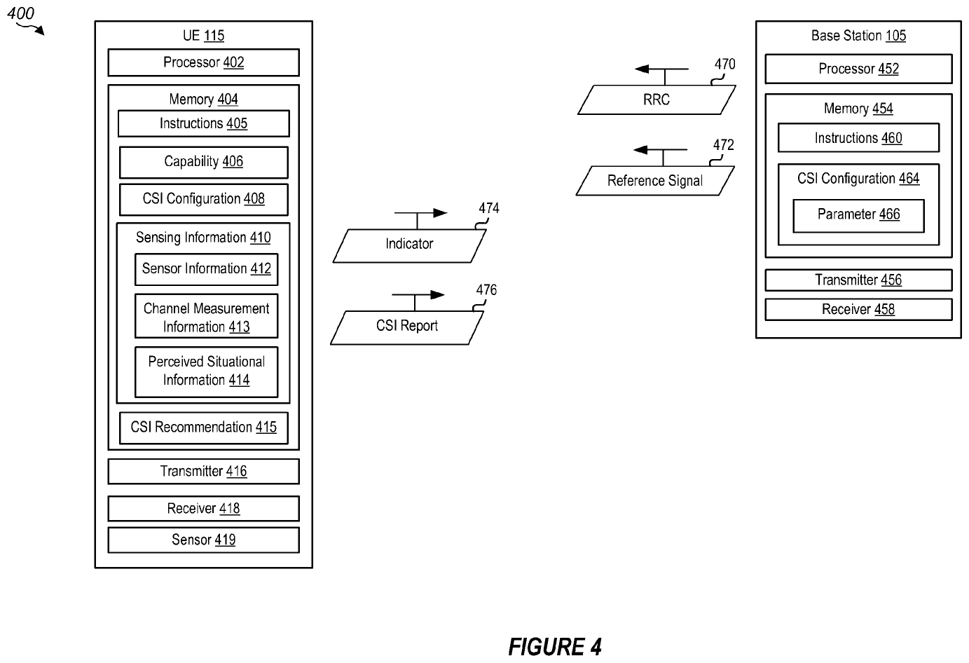

FIG. 4 is a block diagram of an example wireless communications system 400 that supports a CSI configuration recommendation according to one or more aspects. In some examples, wireless communications system 400 may implement aspects of wireless network 100. Wireless communications system 400 includes UE 115 and base station 105. Although one UE 115 and one base station 105 are illustrated, in some other implementations, wireless communications system 400 may generally include multiple UEs 115, multiple base stations 105, or a combination thereof. In some implementations, UE 115 may be a vehicle, such as described further herein at least with reference to FIG. 8.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), one or more receivers 418 (hereinafter referred to collectively as “receiver 418”), and a sensor 419. In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, a capability 406, a CSI configuration 408, sensing information 410, a CSI recommendation 415, or a combination thereof. Capability 406 may include or indicate one or more capabilities of UE 115. In some implementations, UE 115 may communicate its capability 406 to another device, such as base station 105.

CSI configuration 408 may include or indicate a CSI-RS configuration, a CSI reporting scheme, or a combination thereof. For example, CSI configuration 408 may include or indicate a CSI-RS density, a CSI-RS period, a triggering CSI report (e.g., how or when a CSI procedure or time/frequency domain resources should be triggered), or a combination thereof. In some implementations, the CSI-RS configuration may indicate an CSI-RS configuration type. The CSI reporting scheme may indicate a CSI reporting type.

Sensing information 410 may include sensor information 412, channel measurement information 413, perceived situational information 414, or a combination thereof. For example, sensing information 410 may include information associated with reflections associated with the real world perceived by sensing, a channel response from CSI-RS measurement, or a combination thereof.

Sensor information 412 may include information received from or generated by sensor 419. Channel measurement information 413 may include a channel response form a CSI-RS measurement. For example, channel measurement information 413 may include a per-path doppler, which may be dependent on a velocity of UE 115, an angle-of-arrival (AoA), or a combination thereof. Additionally, channel measurement information 413 may include CSI. The CSI may include a channel quality indicator (CQI), a precoding matrix indicator (PMI), a CSI-RS resource indicator (CRI), an SS/PBCH Block Resource indicator (SSBRI), a layer indicator (LI), a rank indicator (RI), an L1-RSRP or an L1-SINR. Channel measurement information 413 may also include or indicate a multipath channel response or an estimate of a multipath channel response, such as a power level or time of receiving a signal.

The perceived situational information 414 may include or indicate information associated with a surrounding or environment of UE 115. For example, the perceived situational information 414 may include or indicate an object (e.g., a building) or a location of the object, reflection locations/sources, or a combination thereof. In some implementations, the perceived situation information 414 is generated based on perceptive sensing performed by UE 115. Perceptive sensing may include measurement of a reference signal by UE 115, generation of sensor information 412 (e.g., real-world data acquisition), or a combination thereof. Perceptive sensing may enable UE 115 to perceive the real world around UE 115.

CSI recommendation 415 may include or indicate a recommended CSI-RS configuration, a recommended CSI reporting scheme, or a combination thereof. For example, the CSI recommendation 415 may include or indicate a CSI-RS configuration type, a CSI reporting type, or a combination thereof. In some implementations, CSI recommendation 415 may include or indicate a CSI report period, CSI-RS density in time, CSI-RS density in frequency, or a combination thereof.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Sensor 419 may include an image capture device (e.g., a camera), a non-camera sensor, or a combination thereof. The non-camera sensor may include a gyroscope, accelerometer, a GPS, a LiDAR system, a RADAR system, or other ranging system, as illustrative, non-limiting examples. In some implementations, sensor 419 is configured to generate sensor information 412.

UE 115 may include one or more components as described herein with reference to UE 115. In some implementations, UE 115 is a 5G-capable UE, a 6G-capable UE, or a combination thereof.

Base station 105 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, base station 105 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460 and a CSI configuration 464. CSI configuration 464 may include or correspond to CSI configuration 408. CSI configuration 464 may include a parameter 466. Parameter 466 may indicate a period of a CSI report, a time domain of a reference signal, a frequency of a reference signal, a mode (e.g., the UE report mode), a threshold, or a combination thereof, as illustrative, non-limiting examples.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2.

In some implementations, base station 105 may include one or more antenna arrays. The antenna array may include multiple antenna elements configured to perform wireless communications with other devices, such as with UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 400 implements a 6G network.

In some implementations, wireless communications system 400 is configured for UE 115 to perform CSI reporting. For example, UE 115 may monitor a channel. Based on monitoring the channel, UE 115 may determine CSI. The CSI may include a CQI, a PMI, a CRI, an SSBRI, an LI, an RI, an L1-RSRP or an L1-SINR.

In some implementations, UE 115 may generate and transmit a CSI report based on the monitored channel. A time resource, a frequency resource, or a combination thereof, that can be used by UE 115 to report CSI may be controlled by base station 105. For example, base station 105 may provide UE 115 with CSI configuration 464 for UE 115 to report CSI. The CSI configuration may be varied, may be configured by the network (e.g., a network entity, base station 105, or core network 130), or a combination thereof. UE 115 can measure a downlink channel and report the downlink channel status to base station 105 so that base station can schedule additional time and frequency resources.

In some implementation, the CSI configuration 408 or 464 may include a CSI-RS configuration, a recommended CSI reporting scheme, or a combination thereof. The CSI-RS configuration may include different types of CSI-RS configurations, such as a periodic CSI-RS configuration, a semi-persistent CSI-RS configuration, an aperiodic CSI-RS configuration, or a combination thereof. Each CSI-RS configuration, such as each type of CSI-RS configuration, may be configured for or support one or more CSI reporting schemes. The one or more reporting schemes may include a periodic CSI reporting, a semi-persistent CSI reporting, an aperiodic CSI reporting, or a combination thereof.

In some implementations, the periodic CSI-RS configuration may be configured for or support periodic CSI reporting which is not dynamically triggered or activated. The semi-persistent CSI-RS configuration, the aperiodic CSI-RS configuration, or both may not be configured for or support periodic CSI reporting. In some implementations, the periodic CSI-RS configuration, the semi-persistent CSI-RS, or both may be configured for or support periodic CSI reporting. For reporting on PUCCH, UE 115 may receive an activation command. Additionally, or alternatively, for reporting on PUSCH, UE 115 may receive a trigger signal on DCI. The aperiodic CSI-RS may not be configured for or support semi-persistent CSI reporting. In some implementations, the periodic CSI-RS configuration, the semi-persistent CSI-RS, or the aperiodic CSI-RS may be configured for or support aperiodic CSI reporting which is triggered by DCI.

UE 115 may be configured to trigger or recommend a CSI procedure or a time/frequency domain resource based on sensing information 410, such as sensor information 412, channel measurement information 413, or a combination thereof. In some implementations, sensing information 410 may include perceived situational information 414, which may be determined or generated based on a combination of sensor information 412 and channel measurement information 413 (e.g., a CSI-RS measurement).

In some implementations, UE 115 may be configured in a UE report mode. The UE report mode may support or enable a CSI recommendation 415. For example, the UE report mode may be a network configured UE report mode or an event triggered UE report mode. In some implementations, the UE report mode may be determined or selected by UE 115, or may be indicated or controlled by base station 105. When the UE report mode is indicated or controlled by base station 105, base station may indicate the UE report mode using RRC signaling, DCI, or other signaling.

UE 115 configured for the network configured UE report mode may receive a request from base station 105 for CSI recommendation 415. For example, base station 105 may include the request in RRC signaling. Additionally, or alternatively, the RRC signaling may include, or the request may be included in, CSI configuration 408 or 464.

In some implementations, base station 105 may know capability 406 of UE 115 and may request UE 115 to determine or provide CSI recommendation 415, such as a recommended CSI-RS configuration, a recommended CSI reporting configuration/scheme, or a combination thereof. Additionally, or alternatively, the request may indicate that the recommendation, or an indication thereof, be communicated in a CSI report or in a report that is separate from a CSI report (e.g., 476). If the recommendation is included in the CSI report, UE 115 may provide CSI recommendation 415 (e.g., different CSI recommendations) based on the periodicity of the CSI report. If the commendation is included in the separate report, the separate report may be scheduled by base station 105. Additionally, or alternatively, the recommendation or the separate report may be included in PUCCH or MAC-CE.

UE 115 configured for the event triggered UE report mode, UE 115 may be configured to generate or transmit CSI recommendation 415, or an indicator of CSI recommendation 415, based on a condition. For example, UE 115 may be configured to detect a condition associated with UE 115. The condition may include includes a change in velocity, a change in a number of spatial domain rays, a change in a line-of-sight (LoS) ray, or a combination thereof, as illustrative, non-limiting examples. To illustrate, UE 115 may detect the condition based on a determine of whether or not a characteristic (e.g., velocity, a number of spatial domain rays, a line-of-sight ray), or a change in a characteristic satisfies a threshold. As an example, when a velocity of UE 115 changes rapidly (e.g., from UE 115 being stationary to moving), a channel state (or a parameter of the channel) may need to be updated in time or frequency. In some implementation, base station 105 or the network may define one or more events to trigger generation or transmission of a CSI report, or an indication of CSI recommendation, by UE 115. For example, base station 105 may define the event (or condition) as a velocity of UE 115 changing greater than or equal to a threshold, such as a threshold amount Th_{velocity}. As another example, base station 105 may define the event (or condition) as a change in a number of spatial domain rays changed, e.g., a LOS ray disappears because of blockage.

In some implementations, UE 115 can generate or transmit a CSI report 476. CSI report 476 may include or indicate a CQI, a PMI, a CRI, an SSBRI, an LI, an RI, an L1-RSRP or an L1-SINR. Additionally, or alternatively, UE 115 can generate or transmit an indicator 474 that indicates CSI recommendation 415. In some implementations, indicator 474 may be included in or an extension of CSI report 476. Including indicator 474 in or as an extension of CSI report 476 may reduce additional overhead or signaling as compared to transmitting indicator 474 separate from CSI report 476.

In some implementations, CSI recommendation 415 or indicator 474 may include or indicate a CSI report period, A SCI-RS density in time, a CSI-RS density in frequency, or a combination thereof. Regarding the CSI report period, if a velocity of UE 115 is less than or equal to a threshold, or channel conditions or blockage from surrounding reflections is considered to be constant, a CSI report period can be large. Alternatively, if a velocity of UE 115 is increasing or high, a short CSI report may be recommended so base station 105 can obtain accurate DL channel information. Regarding the CSI-RS density in time and frequency, a UE measured multi-path doppler (measured by UE 115) based on a velocity and moving direction of UE 115 can be a reference to CSI-RS time domain density. Additionally, or alternatively, UE perceived multi-path reflection and wireless channel association can used to decide and predict frequency domain density.

In some implementations, UE 115 may determine to not send a required or request CSI report (e.g., 476), such as when PMI is supposed to be reported. To illustrate, a determination to not send the required or requested CSI report may be explicitly indicated, such as using a 1 bit indication. As an illustrate, non-limiting example, UE 115 may determine to keep or recommend to keep channel parameters unchanged. When a time (e.g., based on a CSI report period) for providing a CSI report occurs, UE 115 may report PMI report can be reported in a special format, such as a format that indicates that a former (e.g., most recent) CSI report can still be reused.

In some implementations, UE 115 may indicate a CQI offset or PMI update on a certain layer. The CQI offset or the PMI update may be based on a perceived channel parameter change. The channel parameter may include per-path reflection, delay, amplitude, etc., as illustrative, non-limiting examples. UE 115 may be configured to, based on sensing information 410, predict a channel parameter change—e.g., because UE 115 can sense the surrounding world/environment. To illustrate, UE 115 may be moving in a direction and may receive a LOS ray of a reference signal from base station 105. Additionally, UE 115 may receive one or more reflections (e.g., of the reference signal) based on one or more objects in the surrounding world/environment. Without a blockage, a LOS may change slowly (or not at all) and UE 115 may determine that a configuration of the layer contributed by this dominant LoS ray is assumed constant in a period. However, reflection rays can change rapidly due to movement of UE 115 in a dense scenario. To save overhead, such as when CSI codebook mode 2 is enabled, configuration of the remaining layer(s) (other than the layer contributed by the dominant LoS ray)—i.e., coefficient in PMI and CQI offset-may be updated to base station 115. For example, PMI can be reported in a bitmap format, and only the offset/delta for the changed layer(s) is required to be updated to base station 105 for UE 115.

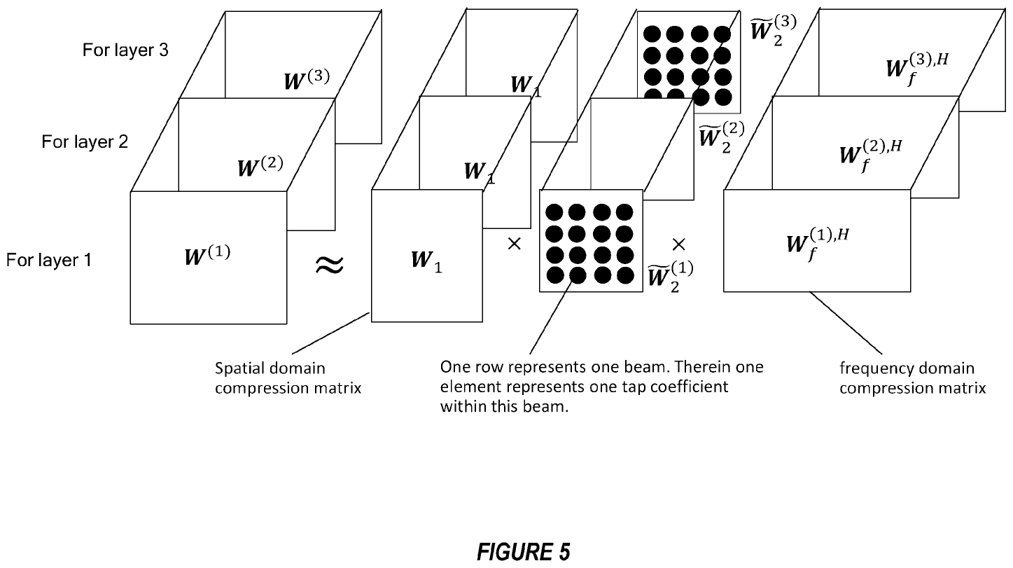

Referring to FIG. 5, FIG. 5 is a diagram illustrating an example of content of a UE report according to one or more aspects. The UE report may include or correspond to indicator 474—e.g., may indicate CSI recommendation 415 or a change to CSI configuration 408. As described above, layer 1 is contributing by the LoS ray and assumed to be stable in a period, configurations for layer 1 needs no update/report to save overhead. When the CSI cookbook mode two is enabled, the UE report includes, for each layer, a spatial domain matrix (W1), a frequency domain matrix (Wf), and a linear combination or coefficients (W2) to combine W1 and WF base station 105 construct the real precoding matrix for each layer. UE 115 that includes sensor information 412 and channel measurement information 413, may determine that the layer 1 is mainly contributed to by the LoS ray and predict or assume that the LoS ray is constant. Because UE 115 knows its speed and direction of travel, UE 115 can predict the spatial domain matrix W1 and the frequency domain Wf. However, layer 2 or layer 3 may have contributions from reflected rays which may be changing and that reflection change can result in the coefficients changing (and needing to be updated) for layer 2 or layer 3. UE 115 in CSI codebook mode 2 that is aware of its surrounding environment can save or reduce overhead by indicating an update of coefficients in PMI and/or CQI offset to base station 105.

Referring again to FIG. 4, in some implementations, UE 115 may be configured to transmit indicator 474 via PUCCH or MAC-CE. For example, UE 115 may transmit indicator 474 periodically via PUCCH. In some implementations, indicator 474 may be included in CSI report 476 and transmitted on PUCCH, such as when UE 115 is configured for the network configured UE report mode. Alternatively, indicator 474 may be included in MAC-CE, such as when UE 115 is configured for the event triggered UE report mode.

During operation of wireless communications system 400, base station 105 may transmit RRC 470 to UE 115. RRC 470 may indicate CSI configuration 464. UE 115 may receive RRC 470 and configure UE 115 based on CSI configuration 464. For example, UE 115 may store or update CSI configuration 408 based on CSI configuration 464 indicated by RRC 470. In some implementations, UE 115 may update a mode of UE 115 based on RRC 470 or CSI configuration 464 indicated by RRC 470.

Base station 105 may transmit reference signal 472 based on CSI configuration 408, 464. UE 115 may receive reference signal 472 and generate channel measurement information 413 based on reference signal 472. Additionally, UE 115 may receive sensor information 412 from sensor 419. UE 115 may determine perceived situational information 414 based on sensor information 412 and channel measurement information 413. In some implementations, UE 115 may detect a condition associated with UE 115. For example, UE 115 may detect the condition based on sensing information 410. The condition includes a change in velocity, a change in a number of spatial domain rays, a change in a line-of-sight ray, a change in a channel parameter, or a combination thereof.

UE 115 may generate, based on sensing information 410, indicator 474 that indicates CSI recommendation 415. CSI recommendation 415 may include a recommended CSI-RS configuration, a recommended CSI reporting scheme, or a combination thereof. UE 115 may transmit indicator 474 to base station 105. Additionally, or alternatively, UE 115 may generate CSI report 476 based on reference signal 472. UE 115 may transmit CSI report 476 to base station 105. In some implementations, indicator 474 may be included in CSI report 476.

In some implementations, bases station 105 may transmit multiple reference signals to UE 115. To illustrate, base station 105 may transmit a first RRC (e.g., 470) that indicates a first CSI configuration (e.g., 464). UE 115 may receive the first RRC and configure UE 115 based on the first CSI configuration. The first RRC or the first CSI configuration may indicate that base station requests a CSI recommendation (e.g., 415) from UE 115. Base station 105 may transmit a first reference signal (e.g., 472). Based on the first reference signal and while configured according to the first CSI configuration, UE 115 may generate a first CSI report (e.g., 476). Additionally, based on first sensing information (e.g., 410), UE 115 may generate a first indicator (e.g., 474) that indicates a first CSI recommendation (e.g., 415). UE 115 may include the first indicator with the first CSI report or transmit the first indicator separate from the first CSI report.

Base station 105 may receive the first indicator and determine a second CSI configuration (e.g., 464) based on the first indicator. Base station 105 may communication an indicator to UE 115 that indicates the second CSI configuration. UE 115 may configure UE 115 based on the second CSI configuration. Base station 105 may transmit a second reference signal (e.g., 472). Based on the second reference signal and while configured according to the second CSI configuration, UE 115 may generate a second CSI report (e.g., 476). Additionally, based on second sensing information (e.g., 410), UE 115 may generate a second indicator (e.g., 474) that indicates change in a coefficient in PMI or a CQI offset (as compared to first CSI report). UE 115 may include the second indicator with the second CSI report or transmit the second indicator separate from the second CSI report.

As described with reference to FIG. 4, the present disclosure provides techniques for supporting a CSI configuration recommendation. The techniques described herein enable UE 115 to generate CSI recommendation 415. In some implementations, CSI recommendation 415 may be generated based on sensing information 410, which may include information of a surrounding environment (e.g., sensor information 412) and channel measurement information 413. By providing the indicator 474 of CSI recommendation 415 to base station 105, UE 115 can enable base station 105 to adjust CSI configuration 408 or 464 in association with changing channel conditions, which may be based on movement of UE 115. Accordingly, base station 105 can react to the changing channel conditions and avoid reduced channel quality or quality of service experienced by UE 115.

FIG. 6 is a flow diagram illustrating an example process 600 that supports a CSI configuration recommendation according to one or more aspects. Operations of process 600 may be performed by a UE, such as UE 115 described above with reference to FIGS. 1-4, a UE described with reference to FIG. 7, or a vehicle described with reference to FIG. 8. For example, example operations (also referred to as “blocks”) of process 500 may enable UE 115 to support a CSI configuration recommendation.

In block 602, the UE generates, based on sensing information, an indicator that indicates a CSI recommendation. The indicator and the CSI recommendation may include or correspond to indicator 474 and CSI recommendation 415, respectively. The CSI recommendation may include a recommended CSI-RS configuration, a recommended CSI reporting scheme, or a combination thereof. Additionally, or alternatively, the CSI recommendation may include a CSI report period, CSI-RS density in time, CSI-RS density in frequency, or a combination thereof.

The sensing information may include or correspond to sensing information 410, sensor information 412, channel measurement information 413, or perceived situational information 414.

In block 604, the UE transmitting the indicator. For example, the indicator may be included in PUCCH or in an MAC-CE.

In some implementations, the UE may receive sensor information from a radar, a camera, Lidar, or a combination thereof. In some implementations, the sensor information may be received from sensor 419. Additionally, or alternatively, the UE may determine a channel measurement based on a reference signal. The reference signal may include or correspond to reference signal 472, and the channel measurement may include or correspond to channel measurement information 413. In some implementations, the UE may determine perceived situational information, such as perceived situational information 414. The perceived situational information may be determined based on the sensor information and the channel measurement. The sensor information may include or correspond to sensor information 412. In some implementations, the sensing information includes the perceived situational information.

r In some implementations, the UE may receive RRC signaling. For example, the UE may receive the RRC signaling from a network entity, such as base station 105. The RRC signaling may include or correspond to base station 105. The RRC signaling may indicate a request for the UE to provide the CSI recommendation, whether the indicator is to be included in a CSI report or transmitted separate from the CSI report, or a combination thereof.

In some implementations, the UE may detect a condition associated with the UE. For example, the condition may include a change in velocity, a change in a number of spatial domain rays, a change in a line-of-sight ray, or a combination thereof. In some such implementations, the indicator may be generated by the UE based on detection of the condition.

In some implementations, the UE may generate a CSI report. The CSI report may include or correspond to CSI report 476. The CSI report includes a CQI, a PMI, a CRI, an SSBRI, an LI, an RI, an L1-RSRP, an L1-SINR, or a combination thereof. Additionally, or alternatively, the UE may transmit the CSI report. The CSI report may indicate no change from a prior CSI report, the prior CSI report includes a PMI report, or a combination thereof. To further explain, the UE may receive sensing information, such as sensing information 410, and determine a change in a channel parameter based on the sensing information. The channel parameter may include a reflection, a delay, an amplitude, or a combination thereof. The CSI report may indicate, based on the change in the channel parameter, a CQI offset or a PMI update for a layer.

FIG. 7 is a block diagram of an example UE 700 that supports a CSI configuration recommendation according to one or more aspects. UE 700 may be configured to perform operations, including the blocks of a process described with reference to FIG. 6. In some implementations, UE 700 includes the structure, hardware, and components shown and described with reference to UE 115 of FIGS. 1-4. For example, UE 700 includes controller 280, which operates to execute logic or computer instructions stored in memory 282, as well as controlling the components of UE 700 that provide the features and functionality of UE 700. UE 700, under control of controller 280, transmits and receives signals via wireless radios 701a-r and antennas 252a-r. Wireless radios 701a-r include various components and hardware, as illustrated in FIG. 2 for UE 115, including modulator and demodulators 254a-r, MIMO detector 256, receive processor 258, transmit processor 264, and TX MIMO processor 266.

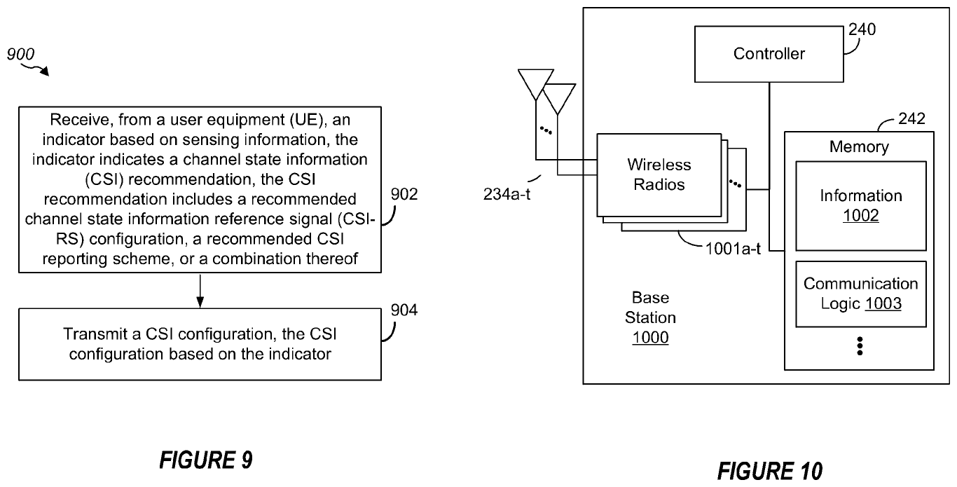

As shown, memory 282 may include information 702 and communication logic 703. Information 702 may include or correspond to capability 406, CSI configuration 408, sensing information 410, sensor information 412, channel measurement information 413, perceived situational information 414, CSI recommendation 415, indicator 474, CSI report 476, CSI configuration 464, parameter 466. Communication logic 703 may be configured to enable communication between UE 700 and one or more other devices. UE 700 may receive signals from or transmit signals to one or more network entities, such as base station 105 of FIGS. 1-4 or a base station as illustrated in FIG. 9.

FIG. 8 is a perspective view of a motor vehicle with a driver monitoring system according to one or more aspects. A vehicle 800 may include or communication with a UE within a wireless network 100, as shown in FIG. 1. In some implementations, vehicle 800 may include or correspond to UE 115i, 115j, or 115k.

Vehicle 800 may include a front-facing camera 812 mounted inside the cabin looking through a windshield 802. Vehicle 800 may also include a cabin-facing camera 814 mounted inside the cabin looking towards occupants of vehicle 800, and in particular the driver of vehicle 800. Although one set of mounting positions for cameras 812 and 814 are shown for vehicle 800, other mounting locations may be used for camera 812 or camera 814. For example, one or more cameras may be mounted on one of the driver or passenger pillars 826 or one of the driver or passenger pillars 828, such as near the top of the pillars 826 or 828. As another example, one or more cameras may be mounted at the front of vehicle 800, such as behind the radiator grill 830 or integrated with bumper 832. As a further example, one or more cameras may be mounted as part of a driver or passenger side mirror assembly 834.

Camera 812 may be oriented such that the field of view of camera 812 captures a scene in front of vehicle 800 in the direction that vehicle 800 is moving when in drive mode or forward direction. In some embodiments, an additional camera may be located at the rear of vehicle 800 and oriented such that the field of view of the additional camera captures a scene behind vehicle 800 in the direction that vehicle 800 is moving when in reverse direction. Although aspects of the disclosure may be described with reference to a “front-facing” camera, referring to camera 812, the aspects of the disclosure may be applied similarly to a “rear-facing” camera facing in the reverse direction of vehicle 800. Thus, the benefits obtained while the operator is operating vehicle 800 in a forward direction may likewise be obtained while the operator is operating vehicle 800 in a reverse direction.

Further, although embodiments of the disclosure may be described with reference a “front-facing” camera, referring to camera 812, aspects of the disclosure may be applied similarly to an input received from an array of cameras mounted around vehicle 800 to provide a larger field of view, which may be as large as 360 degrees around parallel to the ground and/or as large as 360 degrees around a vertical direction perpendicular to the ground. For example, additional cameras may be mounted around the outside of vehicle 800, such as on or integrated in the doors, on or integrated in the wheels, on or integrated in the bumpers, on or integrated in the hood, and/or on or integrated in the roof.

Camera 814 may be oriented such that the field of view of camera 814 is configured to capture a scene in the cabin of vehicle 800 and includes the user operator of vehicle 800. In some implementations, camera 814 is configured to capture the face of the user operator of vehicle 800 with sufficient detail to discern a gaze direction of the user operator.

Each of cameras 812 and 814 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

Vehicle 800 may include, or otherwise be coupled to, an image signal processor for processing image frames from one or more image sensors, such as a first image sensor, a second image sensor, and a depth sensor. Vehicle 800 may further include or be coupled to a power supply, such as a battery or an alternator. Vehicle 800 may also include or be coupled to one or more features of FIG. 2, one or more additional features or components that are not shown in FIG. 2, or a combination thereof.

Vehicle 800 may include a sensor hub for interfacing with sensors to receive data regarding movement of vehicle 800, data regarding an environment around vehicle 800, or other non-camera sensor data. The sensor hub may include or be coupled to one or more sensors, such as sensor 419. One example non-camera sensor is a gyroscope, a device configured for measuring rotation, orientation, or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub may interface to a vehicle bus for sending configuration commands and/or receiving information from vehicle sensors, such as distance (e.g., ranging) sensors or vehicle-to-vehicle (V2V) sensors (e.g., sensors for receiving information from nearby vehicles).

FIG. 9 is a flow diagram illustrating an example process 900 that supports a CSI configuration recommendation according to one or more aspects. Operations of process 900 may be performed by a base station, such as base station 105 described above with reference to FIGS. 1-4 or a base station as described above with reference to FIG. 10. For example, example operations of process 900 may enable base station 105 to support a CSI configuration recommendation.

At block 902, the base station receiving, from a UE, an indicator based on sensing information. The UE may include or correspond to UE 115. In some implementations, the base station may receive PUCCH or an MAC-CE that includes the indicator.

The indicator may include or correspond to 474. The indicator may indicate a CSI recommendation. The CSI recommendation may include or correspond to CSI recommendation 415. The CSI recommendation may include a recommended CSI-RS configuration, a recommended CSI reporting scheme, or a combination thereof. Additionally, or alternatively, the CSI recommendation includes a CSI report period, CSI-RS density in time, CSI-RS density in frequency, or a combination thereof.

The sensing information may include or correspond to sensing information 410, sensor information 412, channel measurement information 413, perceived situational information 414. In some implementations, the sensing information may include perceived situational information, such as the perceived situational information 414. To illustrate, the perceived situational information may be based on a channel measurement associated with a reference signal and sensor information generated by the UE. The reference signal may include or correspond to reference signal 472. The channel measurement and the sensor information may include or correspond to channel measurement information 413 and sensor information 412, respectively.

At block 904, the base station transmitting a CSI configuration. The CSI configuration may include or correspond to CSI configuration 464. The CSI configuration may be based on the indicator.

In some implementations, the base station may transmit RRC signaling. The RRC signaling may include or correspond to RRC 470. The RRC signaling may indicate a request for the UE to provide the CSI recommendation. Additionally, or alternatively, the RRC signaling may indicate that the indicator is to be included in a CSI report or transmitted separate from the CSI report, a condition to initiate generation of the indicator by the UE, or a combination thereof. In some implementations, the condition may include or be associated with a change in velocity, a change in a number of spatial domain rays, or a change in a line-of-sight ray, or a combination thereof.

t In some implementations, the base station may transmit a reference signal. The reference signal may include or correspond to reference signal 472. Additionally, or alternatively, the base station may receive a CSI report based on the reference signal. The CSI report may include or correspond to CSI report 476. The CSI report may include a CQI, a PMI, a CRI, an SSBRI, an LI, an RI, an L1-RSRP, an L1-SINR, or a combination thereof.

In some implementations, the CSI report may indicate no change from a prior report, the prior report includes a PMI report, or a combination thereof. In some other implementations, the CSI report may indicate, based on a change in a channel parameter, a CQI offset or a PMI update for a layer. The channel parameter may be associated with a reflection, a delay, an amplitude, or a combination thereof, sensed by the UE.

FIG. 10 is a block diagram of an example base station 1000 that supports a CSI configuration recommendation according to one or more aspects. Base station 1000 may be configured to perform operations, including the blocks of process 900 described with reference to FIG. 9. In some implementations, base station 1000 includes the structure, hardware, and components shown and described with reference to base station 105 of FIGS. 1-4. For example, base station 1000 may include controller 240, which operates to execute logic or computer instructions stored in memory 242, as well as controlling the components of base station 1000 that provide the features and functionality of base station 1000. Base station 1000, under control of controller 240, transmits and receives signals via wireless radios 1001a-t and antennas 234a-t. Wireless radios 1001a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include information 1002 and communication logic 1003. Information 1002 may include or correspond to capability 406, CSI recommendation 415, indicator 474, CSI report 476, CSI configuration 464, parameter 466, or a combination thereof. Communication logic 1003 may be configured to enable communication between base station 1000 and one or more other devices. Base station 1000 may receive signals from or transmit signals to one or more UEs, such as UE 115 of FIGS. 1-4, UE 700 of FIG. 7, or vehicle 800 of FIG. 8.

It is noted that one or more blocks (or operations) described with reference to FIG. 6 or 9 may be combined with one or more blocks (or operations) described with reference to another of the figures. For example, one or more blocks (or operations) of FIG. 6 may be combined with one or more blocks (or operations) of FIG. 9. As another example, one or more blocks associated with FIG. 6 may be combined with one or more blocks associated with FIG. 4 or 5. As another example, one or more blocks associated with FIG. 6 or 9 may be combined with one or more blocks (or operations) associated with FIGS. 1-4. Additionally, or alternatively, one or more operations described above with reference to FIGS. 1-4 may be combined with one or more operations described with reference to FIGS. 7, 8, or 10.

In one or more aspects, techniques for supporting a CSI configuration recommendation may include additional aspects, such as any single aspect or any combination of aspects described below or in connection with one or more other processes or devices described elsewhere herein. In a first aspect, techniques for supporting a CSI configuration recommendation may include generating, based on sensing information, an indicator that indicates a CSI recommendation. The CSI recommendation includes a recommended CSI-RS configuration, a recommended CSI reporting scheme, or a combination thereof. The techniques may further include transmitting the indicator. In some examples, the techniques in the first aspect may be implemented in a method or process. In some other examples, the techniques of the first aspect may be implemented in a wireless communication device, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the CSI recommendation includes a CSI report period, CSI-RS density in time, CSI-RS density in frequency, or a combination thereof.

In a third aspect, in combination with the first aspect or the second aspect, the techniques further include receiving sensor information from a radar, a camera, Lidar, or a combination thereof.

In a fourth aspect, in combination with the third aspect, the techniques further include determining a channel measurement based on a reference signal.

In a fifth aspect in combination with the fourth aspect, the techniques further include determining perceived situational information based on the sensor information and the channel measurement.

In a sixth aspect, in combination with the fifth aspect the sensing information includes the perceived situational information.

In a seventh aspect, in combination with one or more of the first aspect through the sixth aspect, the techniques further include receiving, from a network entity, RRC signaling.

In an eighth aspect, in combination with one or more of the seventh aspect, the RRC signaling indicates a request for the UE to provide the CSI recommendation.

In a ninth aspect, in combination with one or more of the first aspect through the eighth aspect, the indicator is to be included in a CSI report or transmitted separate from the CSI report, or a combination thereof.

In a tenth aspect, in combination with one or more of the first aspect through the ninth aspect, the techniques further include detecting a condition associated with the UE, the condition includes a change in velocity, a change in a number of spatial domain rays, a change in a line-of-sight ray, or a combination thereof.

In an eleventh aspect, in combination with the tenth aspect, the indicator is generated based on detection of the condition.

In a twelfth aspect, in combination with one or more of the first aspect through the eleventh aspect, the techniques further include generating a CSI report.

In a thirteenth aspect, in combination with the twelfth aspect, the techniques further include transmitting the CSI report.

In a fourteenth aspect, in combination with the twelfth aspect or the thirteenth aspect, the CSI report includes a CQI, a PMI, a CRI, an SSBRI, an LI, an RI, an L1-RSRP, an L1-SINR, or a combination thereof.

In a fifteenth aspect, in combination with one or more of the twelfth aspect through the fourteenth aspect, the CSI report indicates no change from a prior CSI report.

In a sixteenth aspect, in combination with the fifteenth aspect, the prior CSI report includes a PMI report.

In a seventeenth aspect, in combination with one or more of the first aspect through the sixteenth aspect, the techniques further include receiving sensing information.

In an eighteenth aspect, in combination with the seventeenth aspect, the techniques further include determining a change in a channel parameter based on the sensing information, the channel parameter includes a reflection, a delay, an amplitude, or a combination thereof.

In a nineteenth aspect, in combination with eighteenth aspect, the CSI report indicates, based on the change in the channel parameter, a CQI offset or a PMI update for a layer.

In a twentieth aspect, in combination with one or more of the first aspect through the nineteenth aspect, the indicator is included in PUCCH or in an MAC-CE.

In one or more aspects, techniques for supporting a CSI configuration recommendation may include additional aspects, such as any single aspect or any combination of aspects described below or in connection with one or more other processes or devices described elsewhere herein. In a twenty-first aspect, techniques for supporting a CSI configuration recommendation may include receiving, from a UE, an indicator based on sensing information. The indicator indicates a CSI recommendation. The CSI recommendation includes a recommended CSI-RS configuration, a recommended CSI reporting scheme, or a combination thereof. The techniques may further include generating or transmitting a CSI configuration. The CSI configuration is based on the indicator. In some examples, the techniques in the twenty-first aspect may be implemented in a method or process. In some other examples, the techniques of the twenty-first aspect may be implemented in a wireless communication device, such as network entity, which may include a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a twenty-second aspect, in combination with the twenty-first aspect, the sensing information includes perceived situational information.

In a twenty-third aspect, in combination with the twenty-second aspect, the perceived situational information is based on a channel measurement associated with a reference signal and sensor information generated by the UE.

In a twenty-fourth aspect, in combination with one or more of the twenty-first aspect through the twenty-third aspect, the CSI recommendation includes a CSI report period, CSI-RS density in time, CSI-RS density in frequency, or a combination thereof.

In a twenty-fifth aspect, in combination with one or more of the twenty-first aspect through the twenty-fourth aspect, the techniques further include receiving PUCCH or an MAC-CE that includes the indicator.

In a twenty-sixth aspect, in combination with one or more of the twenty-first aspect through the twenty-fifth aspect, the techniques further include transmitting RRC signaling.

In a twenty-seventh aspect, in combination with the twenty-sixth aspect, the RRC signaling indicates a request for the UE to provide the CSI recommendation.

In a twenty-eighth aspect, in combination with the twenty-sixth aspect or the twenty-seventh aspect, the RRC signaling indicates whether the indicator is to be included in a CSI report or transmitted separate from the CSI report.

In a twenty-ninth aspect, in combination with one or more of the twenty-sixth aspect aspect through the twenty-eighth aspect, the RRC signaling indicates a condition to initiate generation of the indicator by the UE, the condition including a change in velocity, a change in a number of spatial domain rays, or a change in a line-of-sight ray.

In a thirtieth aspect, in combination with one or more of the twenty-first aspect through the twenty-ninth aspect, the techniques further include transmitting a reference signal.

In a thirty-first aspect, in combination with the thirtieth aspect, the techniques further include receiving a CSI report based on the reference signal.

In a thirty-second aspect, in combination with the thirty-first aspect, the CSI report includes a CQI, a PMI, a CRI, an SSBRI, an LI, an RI, an L1-RSRP, an L1-SINR, or a combination thereof.

In a thirty-third aspect, in combination the thirty-first aspect or the thirty-second aspect, the CSI report indicates no change from a prior report, the prior report includes a PMI report, or a combination thereof.

In a thirty-fourth aspect, in combination with the thirty-first aspect or the thirty-second aspect, the CSI report indicates, based on a change in a channel parameter, a CQI offset or a PMI update for a layer.

In a thirty-fifth aspect, in combination with the thirty-fourth aspect, the channel parameter is associated with a reflection, a delay, an amplitude, or a combination thereof, sensed by the UE.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
generating, based on sensing information, an indicator that indicates a channel state information (CSI) recommendation, the CSI recommendation includes a recommended channel state information reference signal (CSI-RS) configuration, a recommended CSI reporting scheme, or a combination thereof; and
transmitting the indicator.

2. The method of claim 1, wherein the CSI recommendation includes a CSI report period, CSI-RS density in time, CSI-RS density in frequency, or a combination thereof.

3. The method of claim 1, further comprising:
receiving sensor information from a radar, a camera, Lidar, or a combination thereof;
determining a channel measurement based on a reference signal; and
determining perceived situational information based on the sensor information and the channel measurement, wherein the sensing information includes the perceived situational information.

4. The method of claim 1, further comprising:
receiving, from a network entity, radio resource control (RRC) signaling, and
wherein the RRC signaling indicates a request for the UE to provide the CSI recommendation, whether the indicator is to be included in a CSI report or transmitted separate from the CSI report, or a combination thereof.

5. The method of claim 1, further comprising:
detecting a condition associated with the UE, the condition includes a change in velocity, a change in a number of spatial domain rays, a change in a line-of-sight ray, or a combination thereof, and
wherein the indicator is generated based on detection of the condition.

6. The method of claim 1, further comprising:
generating a CSI report; and
transmitting the CSI report, and
wherein the CSI report includes a channel quality indicator (CQI), a precoding matrix indicator (PMI), a CSI-RS resource indicator (CRI), a synchronization signal/physical broadcast channel block resource indicator (SSBRI), a layer indicator (LI), a rank indicator (RI), a layer 1 reference signal received power (L1-RSRP), a layer 1 signal-to-noise and interference ratio(L1-SINR), or a combination thereof.

7. The method of claim 6, wherein:
the CSI report indicates no change from a prior CSI report;
the prior CSI report includes a PMI report; or
a combination thereof.

8. The method of claim 6, further comprising:
receiving sensing information;
determining a change in a channel parameter based on the sensing information, the channel parameter includes a reflection, a delay, an amplitude, or a combination thereof; and
the CSI report indicates, based on the change in the channel parameter, a CQI offset or a PMI update for a layer.

9. The method of claim 1, wherein the indicator is included in physical uplink control channel (PUCCH) or in a medium access control-control element (MAC-CE).

10. A user equipment (UE) comprising:
a memory storing processor-readable code; and
at least one processor coupled to the memory, the at least one processor configured to execute the processor-readable code to cause the at least one processor to:
generate, based on sensing information, an indicator that indicates a channel state information (CSI) recommendation, the CSI recommendation includes a recommended channel state information reference signal (CSI-RS) configuration, a recommended CSI reporting scheme, or a combination thereof; and
transmit the indicator.

11. The UE of claim 10, wherein the at least one processor is configured to execute the processor-readable code to cause the at least one processor to:
receive sensor information from a radar, a camera, Lidar, or a combination thereof;
determine a channel measurement based on a reference signal; and
determine perceived situational information based on the sensor information and the channel measurement, the sensing information includes the perceived situational information, and
wherein the CSI recommendation includes a CSI report period, CSI-RS density in time, CSI-RS density in frequency, or a combination thereof.

12. The UE of claim 10, wherein the at least one processor is configured to execute the processor-readable code to cause the at least one processor to:
receive, from a network entity, radio resource control (RRC) signaling, and
wherein the RRC signaling indicates a request for the UE to provide the CSI recommendation, whether the indicator is to be included in a CSI report or transmitted separate from the CSI report, or a combination thereof.

13. The UE of claim 10, wherein the at least one processor is configured to execute the processor-readable code to cause the at least one processor to:
detect a condition associated with the UE, the condition includes a change in velocity, a change in a number of spatial domain rays, a change in a line-of-sight ray, or a combination thereof, and
wherein the indicator is generated based on detection of the condition.

14. The UE of claim 10, wherein the at least one processor is configured to execute the processor-readable code to cause the at least one processor to:
generate a CSI report; and
transmit the CSI report, and
wherein the CSI report includes a channel quality indicator (CQI), a precoding matrix indicator (PMI), a CSI-RS resource indicator (CRI), a synchronization signal/physical broadcast channel block resource indicator (SSBRI), a layer indicator (LI), a rank indicator (RI), a layer 1 reference signal received power (L1-RSRP), a layer 1 signal-to-noise and interference ratio (L1-SINR), or a combination thereof.

15. The UE of claim 14, wherein:
the CSI report indicates no change from a prior CSI report;
the prior CSI report includes a PMI report; or
a combination thereof.

16. The UE of claim 14, wherein the at least one processor is configured to execute the processor-readable code to cause the at least one processor to:
receive sensing information;
determine a change in a channel parameter based on the sensing information, the channel parameter includes a reflection, a delay, an amplitude, or a combination thereof; and
the CSI report indicates, based on the change in the channel parameter, a CQI offset or a PMI update for a layer.

17-23. (canceled)

24. A base station comprising:
a memory storing processor-readable code; and
at least one processor coupled to the memory, the at least one processor configured to execute the processor-readable code to cause the at least one processor to:
receive, from a user equipment (UE), an indicator based on sensing information, the indicator indicates a channel state information (CSI) recommendation, the CSI recommendation includes a recommended channel state information reference signal (CSI-RS) configuration, a recommended CSI reporting scheme, or a combination thereof; and
transmit a CSI configuration, the CSI configuration based on the indicator.

25. The base station of claim 24, wherein:
the sensing information includes perceived situational information, the perceived situational information is based on a channel measurement associated with a reference signal and sensor information generated by the UE, and
the CSI recommendation includes a CSI report period, CSI-RS density in time, CSI-RS density in frequency, or a combination thereof.

26. The base station of claim 24, further comprising receiving physical uplink control channel (PUCCH) or a medium access control-control element (MAC-CE) that includes the indicator.

27. The base station of claim 24, the at least one processor is configured to execute the processor-readable code to cause the at least one processor to:
transmit radio resource control (RRC) signaling, and
wherein the RRC signaling indicates:
a request for the UE to provide the CSI recommendation,
whether the indicator is to be included in a CSI report or transmitted separate from the CSI report,
a condition to initiate generation of the indicator by the UE, the condition including a change in velocity, a change in a number of spatial domain rays, or a change in a line-of-sight ray, or
a combination thereof.

28-30. (canceled)
